(19) United States
(12) Patent Application Publication
(10) Pub. No.: US 2016/0179179 A1
(43) Pub. Date: Jun. 23, 2016

(54) CONTROLLER, POWER SUPPLY DEVICE, AND DISPLAY DEVICE HAVING THE POWER SUPPLY DEVICE

(71) Applicant: SAMSUNG DISPLAY CO., LTD., Yongin-City (KR)

(72) Inventors: Bo-Young AN, Hwaseong-si (KR); Yun-Ki BAE, Incheon (KR); Ho-Suk MAENG, Seoul (KR); Young-Min BAE, Seoul (KR)

(21) Appl. No.: 14/702,888

(22) Filed: May 4, 2015

(30) Foreign Application Priority Data
Dec. 18, 2014 (KR) 10-2014-0183418

(51) Int. Cl. G06F 1/32; G09G 3/36; G06F 1/26; G09G 3/32

(52) U.S. Cl. CPC G06F 1/3265; G09G 3/3208; G09G 3/3696; G06F 1/263; G09G 2330/021

(57) ABSTRACT

A power supply device includes a first power generator, a second power generator, and a power selector. The first power generator generates a first power voltage of a first voltage level in a first display mode and a second voltage level in a transition period between the first display mode and a second display mode. The second power generator generates a second voltage. The power selector selects a driving power to provide the first power voltage to a power supply line in the first display mode, the second power voltage to the power supply line in the second display mode, and the first power voltage and the second power voltage to the power supply line in the transition period.

### CROSS REFERENCE TO RELATED APPLICATION

Korean Patent Application No. 10-2014-0183418, filed on Dec. 18, 2014, and entitled, “Power Supply Device and Display Device Having the Same,” is incorporated by reference herein in its entirety.

### BACKGROUND

1. Field

One or more embodiments described herein relate to a power supply device and a display device having a power supply device.

2. Description of the Related Art

A pixel in an organic light emitting display emits a light based on a driving current. The driving current is generated based on the voltage level of a data signal and a power voltage. The power voltage is generated by a power generator in the display.

In an attempt to reduce power consumption, one type of display has been developed to operate in a plurality of modes. Examples of the modes include a normal display mode and a power saving display mode. When operating in power saving mode, power consumption is reduced relative to the normal display mode.

In such a display, the pixels receive power voltages from different power generators based on the mode. When the mode is changed, one power generator may be damaged by the power voltage generated by the other power generator.

### SUMMARY

In accordance with one or more embodiments, a display device includes a display panel including a pixel connected to a power supply line; a panel driver to drive the display panel; a timing controller to control the panel driver; a first power generator to generate a first power voltage of a first voltage level in a first display mode and a second voltage level in a transition period between the first display mode and a second display mode; a second power generator to generate a second power voltage; and a power selector to select a driving power to provide the first power voltage to the power supply line in the first display mode, the second power voltage to the power supply line in the second display mode, and the first power voltage and the second power voltage to the power supply line in the transition period.

The second voltage level may be in a voltage resistant range which the second power generator tolerates. The voltage resistant range may include a voltage level of the second power voltage. The second power generator may be in the panel driver. The power selector may select the driving power by controlling a first output impedance of the first power generator and a second output impedance of the second power generator.

The transition period may include a first period and a second period, the first power voltage of the second voltage level may be applied to the power supply line in the first period, and the second power voltage and the first power voltage of the second voltage level may be applied to the power supply line in the second period. A time length of the first period may be substantially equal to a time length of one frame.

The power selector may include a first switch between the first power generator and the power supply line; and a second switch between the second power generator and the power supply line. The first switch may be turned on in the first display mode and the transition period and may be turned off in the second display mode, and the second switch may be turned off the first display mode and the first period and may be turned on in the second display mode and the second period. The power controller may control the first power generator. The power controller may be in the panel driver.

The power controller may generate a voltage control signal, and the first power generator may generate the first power voltage of the first voltage level or the second voltage level based on the voltage control signal. The power controller may generate a selection control signal, and the power selector may select the driving power based on the selection control signal.

A first time length of one frame in the first display mode may be different from a second time length of one period in the second display mode. The first time length may be shorter than the second time length. Less power may be consumed in the second display mode than in the first display mode.

In accordance with one or more other embodiments, a power supply device includes a first power generator to generate a first power voltage of a first voltage level in a first display mode and a second voltage level in a transition period between the first display mode and a second display mode; a second power generator to generate a second voltage; and a power selector to select a driving power to provide the first power voltage to a power supply line in the first display mode, the second power voltage to the power supply line in the second display mode, and the first power voltage and the second power voltage to the power supply line in the transition period.

The second voltage level may be in a voltage resistant range which the second power generator tolerates. The voltage resistant range may include a voltage level of the second power voltage. The transition period may include a first period and a second period, the first power voltage of the second voltage level may be applied to the power supply line in the first period, and the second power voltage and the first power voltage of the second voltage level may be applied to the power supply line in the second period.

In accordance with one or more other embodiments, a controller includes an interface and a selector to output signals through the interface, the signals to select a first power voltage for output to a power supply line in a first display mode, a second power voltage for output to the power supply line in the second display mode, and the first and second power voltages for output to the power supply line in a transition period between the first mode and the second mode, wherein at least one of the first and second power voltages has a different level in the transition mode than in the first and second display modes and wherein the level of the first power voltage is in a predetermined tolerance range of a power generator in the transition period.

The first power voltage may be output from a first generator and the second power voltage is output from a second generator. The selector may generate one or more first signals to control output impedance of the first and second generators in the first display mode, may generate one or more second signals to control output impedance of the first and second generators in the second display mode, and may generate one or more third signals to control output impedance of the first and second generators in the transition period.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates examples of power voltages for the display device;

FIG. 3 illustrates another embodiment of a display device;

FIG. 4 illustrates an embodiment of a power supply device;

FIG. 5 illustrates an embodiment of a power supply generator;

FIG. 6 illustrates an example of the operation of the power supply generator; and

FIG. 7 illustrates another example of operation of the power supply generator.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout. The embodiments may be combined to form additional embodiments.

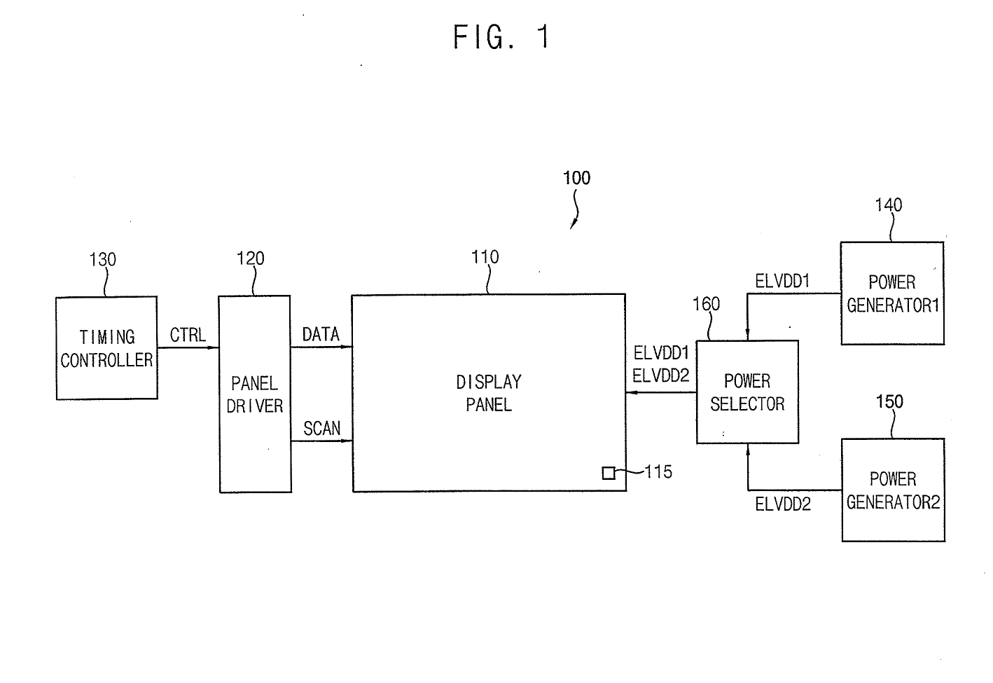

FIG. 1 illustrates an embodiment of a display device 100 which includes a display panel 110, a panel driver 120, a timing controller 130, a first generator 140 a second generator 150, and a power selector 160.

The display panel 110 include at least one pixel 115 connected to a power supply line. The pixel 115 receives a scan signal SCAN via a scan line and a data signal DATA via a data line. The pixel 115 may receive the data signal DATA when the scan signal SCAN is activated. The pixel 115 emits light or control penetration of back light. The display device 100 may be, for example, an organic light emitting display device. In this case, the pixel 115 generates driving current based on the data signal DATA and light is emitted based on the driving current. In another embodiment, the display panel 210 may be a liquid crystal display.

The panel driver 120 drives the display panel 110. The timing controller 130 controls the panel driver 120. The timing controller 130 generates a driver control signal CTRL, and the panel driver 120 generates the scan signal SCAN and the data signal DATA. For example, the panel driver 120 may activate or deactivate the scan signal SCAN based on the driver control signal CTRL. Also, the panel driver 120 may generate the data signal DATA based on the driver control signal CTRL and provide the data signal DATA to the pixel 115.

The first power generator 140 may generate a first power voltage ELVDD1. The first power voltage ELVDD1 may have a first voltage level in a first display mode and a second voltage level in a transition period between the first display mode and a second display mode. For example, the first display mode may be a normal display mode and the second display mode may be a power saving display mode, e.g., a reduced power mode. In another embodiment, the first and second display modes may be different reduced power modes.

The voltage level for the first display mode is different from the voltage level for the second display mode. For example, the panel driver 120 may drive the display panel 110 using, for example, a blockwise driving technique. The blockwise driving technique simultaneously compensates a threshold voltage of each pixel in the block to secure a compensation time for the threshold voltage. The blockwise driving technique drives the pixels in units of blocks. In one example, the voltage level for the first display mode may be 9V, and the voltage level for the second display mode may be 6V. In other embodiments, the panel driver 120 may drive the display panel 110 using a different method or technique and/or the voltage levels for the first and second display modes may be different.

In one example embodiment, a second power consumption consumed by the pixel 115 in the second display mode may be lower than a first power consumption consumed by the pixel 115 in the first display mode. The display device 100 may be included, for example in a portable device. The portable device may include, for example, a battery having a limited battery capacity.

To promote efficient use of the battery, the portable device may reduce power consumption in different situations. The display device 100 may therefore change the display mode in these situations to reduce power consumption. For example, power consumption may be reduced by selecting the second display mode, e.g., changing from the first display mode to a second display mode.

In one example embodiment, a first time length of one frame in the first display mode may be different from a second time length of one period in the second display mode. For example, the first time length may be shorter than the second time length. Also, the frequency of the second display mode may be lower than the frequency of the first display mode. In this case, the second power consumption in the second display mode may be reduced by setting the second time length longer than the first time length.

In one example embodiment, the second voltage level may be in a voltage resistant range which the second power generator 150 may tolerate. The voltage resistant range may include, for example, a voltage level of the second power voltage ELVDD2. The voltage resistance range may be a different range in another embodiment.

The second power generator 150 generates the second power voltage ELVDD2. The second power generator 150 may be included in or coupled to the panel driver 120. The second power consumption of the pixel 115 in the second display mode may be lower than the first power consumption of the pixel 115 in the first display mode. Therefore, the output voltage of the second power generator 150 may be lower than the output voltage of the first power generator 140. Thus, the panel driver 120 may generate the second power voltage ELVDD2.

The power selector 160 selects the driving power to provide the first power voltage ELVDD1 to the power supply line in the first display mode, to provide the second power voltage ELVDD2 to the power supply line in the second display mode, and to provide the first power voltage ELVDD1 and the second power voltage ELVDD2 to the power supply line in the transition period. The first power voltage ELVDD1 and the second power voltage ELVDD2 may be simultaneously applied to the power supply line in the transition period. Therefore, an output terminal of the first power generator 140 may be electrically connected to an output terminal of the second power generator 150. Because the first power voltage ELVDD1 has the second voltage level in the transition period, the first power generator 140 and/or the second power generator 150 may be not damaged.

In one example embodiment, the power selector 160 selects the driving power by controlling a first output impedance of the first power generator 140 and a second output impedance of the second power generator 150. The output terminal of the first power generator 140 and the output terminal of the second power generator 150 are connected to the power supply line. The power selector 160 increases the first output impedance of the first power generator 140 (e.g., to a Hi-Z state) in order to effectively disconnect the output terminal of the first power generator 140 from the power supply line. The power selector 160 increases the second output impedance of the second power generator 150 (e.g., to the Hi-Z state) to effectively disconnect the output terminal of the second power generator 150 from the power supply line.

Furthermore, the power selector 160 decreases the first output impedance of the first power generator 140 and the second output impedance of the second power generator 150 to respectively connect the output terminal of the first power generator 140 to the power supply line and the output terminal of the second power generator 150 to the power supply line. The power selector 160 selects driving power in this manner.

In one example embodiment, the transition period may include a first period and a second period. The first power voltage ELVDD1 having the second voltage level may be applied to the power supply line in the first period. The second power voltage ELVDD2 and the first power voltage ELVDD1 having the second voltage level may be applied to the power supply line in the second period. For example, after the first power voltage ELVDD1 is changed to the second voltage level in the first period, the power selector 160 may provide the second power voltage ELVDD2 and the first power voltage ELVDD1 having the second voltage level to the power supply line in the second period. The time length of the first period may be substantially the same as the time length of one frame. In another embodiment, the time length of the first period may have a different length, e.g., a predetermined fraction of the time length of a frame or greater than the time length of one frame.

In one example embodiment, the power selector 160 includes a first switch and a second switch. The first switch is between the first power generator 140 and the power supply line. The second switch is between the second power generator 150 and the power supply line. The first switch is turned on in the first display mode and the transition period and is turned off in the second display mode. The second switch is turned off the first display mode and the first period and is turned on in the second display mode and the second period. The power selector 160 selects driving power by controlling the first and second switches.

In one example embodiment, the display device 100 may include a power controller to control the first power generator 140. The power controller may be included in or coupled to the panel driver 120. The power controller generates a voltage control signal, and the first power generator 140 generates the first power voltage ELVDD1 having the first voltage level or the second voltage level based on the voltage control signal. The power controller may further generate a selection control signal, and the power selector 160 may select the driving power based on the selection control signal.

Because the first power generator 140 generates the first power voltage ELVDD1 having the second voltage level in the transition period, the display mode of the display device 100 may be changed without damaging the first power generator 140 and/or the second power generator 150.

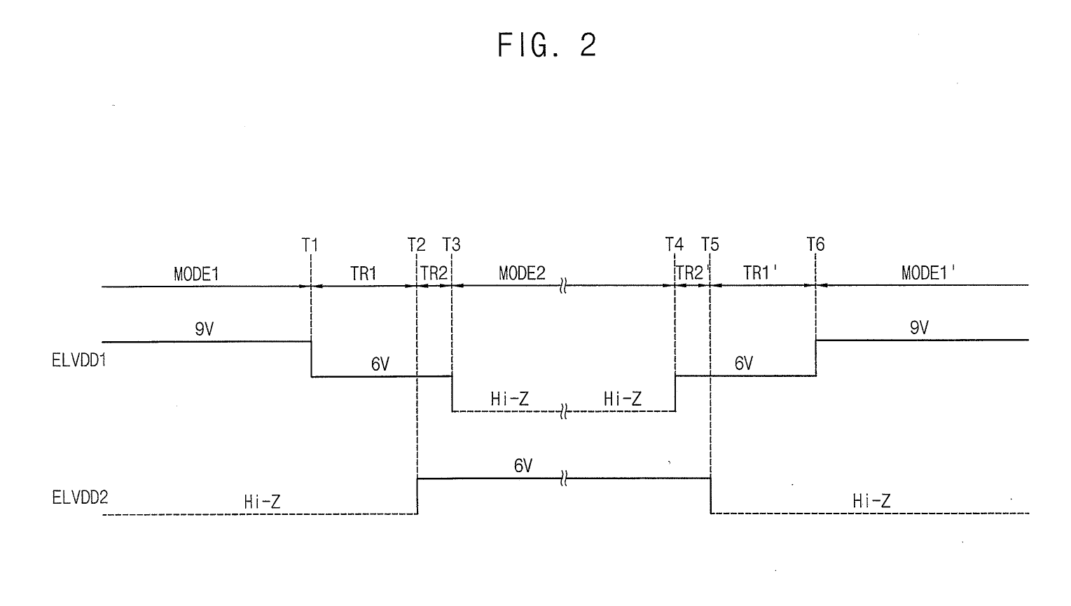

FIG. 2 illustrates examples of the first power voltage generated by the first power generator and the second power voltage generated by the second power generator in the display device of FIG. 1.

Referring to FIG. 2, the first power generator generates the first power voltage ELVDD1 of 9V in a first display mode MODE1 before a first time point T1. The first power generator generates the first power voltage ELVDD1 of 6V in a first transition period between the first time point T1 and third time point T3. The first transition period includes a first period TR1 and a second period TR2. A first output impedance of the first power generator is increased (e.g., to a Hi-Z state) in the second display mode MODE2 between the third time point T3 and a fourth time point T4. The first power generator generates the first power voltage ELVDD1 of 6V in a second transition period between the fourth time point T4 and a sixth time point T6. The second transition period includes a third period TR2′ and a fourth period TR1′. The first power generator generates the first power voltage ELVDD1 of 9V in a first display mode MODE1′ after the sixth time point T6.

The second impedance of the second power generator is increased (e.g., to a Hi-Z state) in the first display mode MODE1 and the first period TR1 before a second time point T2. The second power generator generates the second power voltage ELVDD2 of 6V in the second period TR2, the second display mode MODE2, and the third period TR2′ between the second time point T2 and a fifth time point T5. The second impedance of the second power generator is increased (e.g., to a Hi-Z state) in the first display mode MODE1′ and the first period TR1′ after the fifth time point T5.

The output terminal of the first power generator and the output terminal of the second power generator are connected to a power supply line. Therefore, the power selector may select the driving power by controlling the first output impedance of the first power generator and the second output impedance of the second power generator.

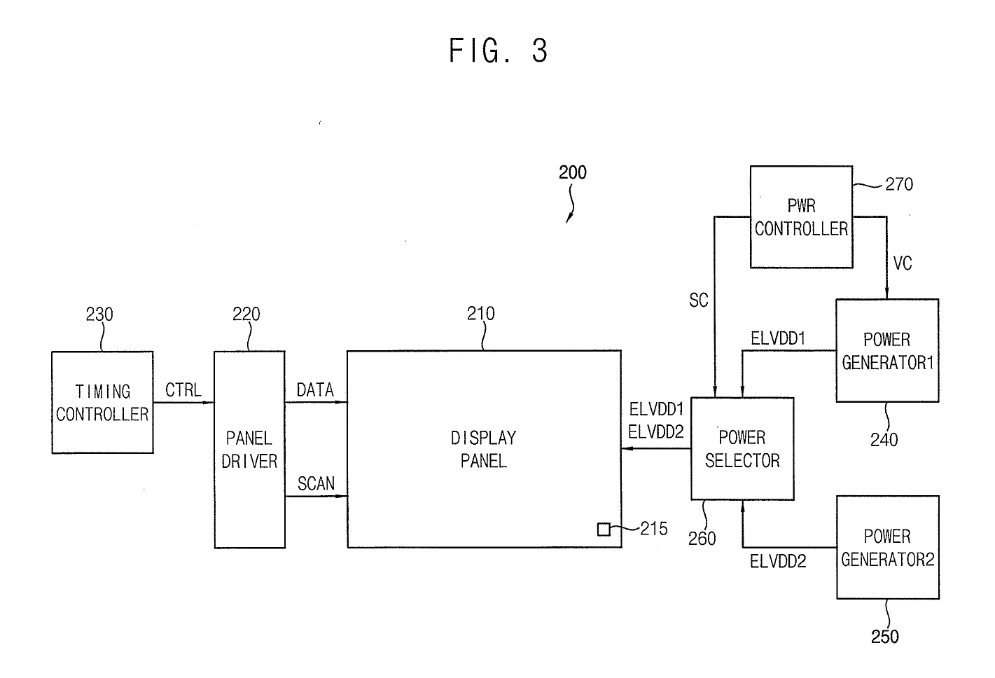

FIG. 3 illustrates another embodiment of a display device 200 which includes a display panel 210, a panel driver 220, a timing controller 230, a first generator 240 a second generator 250, a power selector 260, and a power controller 270.

The display panel 210 includes at least one pixel 215 connected to a power supply line. The pixel 215 receives a scan signal SCAN via a scan line and a data signal DATA via a data line. The pixel 215 may receive the data signal DATA when the scan signal SCAN is activated. The pixel 215 emits a light or controls penetration of back light. The display device 200 may be, for example, an organic light emitting display device. In this case, the pixel 215 generates driving current based on the data signal DATA and light is emitted based on the driving current. In another embodiment, the display panel 210 may be a liquid crystal display.

The panel driver 220 drives the display panel 210. The timing controller 230 controls the panel driver 220. The timing controller 230 may generate a driver control signal CTRL. The panel driver 220 generates the scan signal SCAN and the data signal DATA. For example, the panel driver 220 may activate or deactivate the scan signal SCAN based on the driver control signal CTRL. Also, the panel driver 220 may generate the data signal DATA based on the driver control signal CTRL and provide the data signal DATA to the pixel 215.

The first power generator 240 generates a first power voltage ELVDD1 having a first voltage level in a first display mode and a second voltage level in a transition period. The transition period is located between the first display mode and a second display mode. The first and second display modes may be the same modes as in the previous embodiment. For example, the first display mode may be a normal display mode and the second display mode may be a power saving display mode, e.g., a reduced power mode. In another embodiment, the first and second display modes may be different reduced power modes.

The voltage level for the first display mode is different from the voltage level for the second display mode. For example, the panel driver 220 may drive the display panel 210, for example, using a blockwise driving technique. The blockwise driving technique simultaneously compensates a threshold voltage of each pixel included in the block to secure a compensation time for the threshold voltage. The blockwise driving technique drives the pixels in units of blocks. The voltage level for the first display mode may be 9V and the voltage level for the second display mode may be 6V. In another embodiment, a different method or technique may be used to drive the display panel 210.

In one example embodiment, the second power consumption of the pixel 215 in the second display mode may be lower than a first power consumption consumed of the pixel 215 in the first display mode. The display device 200 may be included in or coupled to a portable device. The portable device may include, for example, a battery having a limited battery capacity. To promote efficient use of the battery, the portable device may reduce power consumption in different situations. For example, the display device 200 may change the display mode according to the different situations to reduce power consumption.

For example, the power consumption of the display device 200 may be reduced by selecting the second display mode. In one example embodiment, the first time length of one frame in the first display mode may be different from the second time length of one period in the second display mode. For example, the first time length may be shorter than the second time length. The frequency of the second display mode may be lower than the frequency of the first display mode. As a result, the second power consumption in the second display mode may be reduced by setting the second time length longer than the first time length.

In one embodiment, the second voltage level may be in a voltage resistant range which the second power generator 250 may tolerate. The voltage resistant range may include, for example, a voltage level of the second power voltage ELVDD2.

The second power generator 250 generates the second power voltage ELVDD2. The second power generator 250 may be included in or coupled to the panel driver 220. The second power consumption of the pixel 215 in the second display mode may be lower than the first power consumption of the pixel 215 in the first display mode. Therefore, the output voltage of the second power generator 250 may be lower than the output voltage of the first power generator 240. Thus, the panel driver 220 may generate the second power voltage ELVDD2.

The power selector 260 selects driving power to provide the first power voltage ELVDD1 to the power supply line in the first display mode, to provide the second power voltage ELVDD2 to the power supply line in the second display mode, and to provide the first power voltage ELVDD1 and the second power voltage ELVDD2 to the power supply line in the transition period. The first power voltage ELVDD1 and the second power voltage ELVDD2 may be simultaneously applied to the power supply line in the transition period. Therefore, the output terminal of the first power generator 240 may be electrically connected to an output terminal of the second power generator 250. Because the first power voltage ELVDD1 has the second voltage level in the transition period, the first power generator 240 and/or the second power generator 250 may be not damaged.

In one example embodiment, the power selector 260 selects driving power by controlling a first output impedance of the first power generator 240 and a second output impedance of the second power generator 250. The output terminal of the first power generator 240 and the output terminal of the second power generator 250 are connected to the power supply line. The power selector 260 increases the first output impedance of the first power generator 240 (e.g., to a Hi-Z state) to effectively disconnect the output terminal of the first power generator 240 from the power supply line. The power selector 260 increases the second output impedance of the second power generator 250 (e.g., to a Hi-Z state) to effectively disconnect the output terminal of the second power generator 250 from the power supply line.

Further, the power selector 260 decreases the first output impedance of the first power generator 240 and the second output impedance of the second power generator 250 to respectively connect the output terminal of the first power generator 240 to the power supply line and the output terminal of the second power generator 250 to the power supply line. The power selector 260 selects driving power in this manner.

In one example embodiment, the transition period may include a first period and a second period. The first power voltage ELVDD1 of the second voltage level may be applied to the power supply line in the first period. The second power voltage ELVDD2 and the first power voltage ELVDD1 of the second voltage level may be applied to the power supply line in the second period. For example, after the first power voltage ELVDD1 is changed to have the second voltage level in the first period, the power selector 260 may provide the second power voltage ELVDD2 and the first power voltage ELVDD1 at the second voltage level to the power supply line in the second period. The time length of the first period may be substantially the same as the time length of one frame. In another embodiment, the time length of the first period may be less than or greater than one frame.

In one example embodiment, the power selector 260 includes a first switch and a second switch. The first switch is between the first power generator 240 and the power supply line. The second switch is between the second power generator 250 and the power supply line. The first switch is turned on in the first display mode and the transition period and is turned off in the second display mode. The second switch is turned off the first display mode and the first period and is turned on in the second display mode and the second period. The power selector 260 selects the driving power by controlling the first and second switches.

The power controller 270 controls the first power generator 240. The power controller 270 may be included in or coupled to the panel driver 220. In one example embodiment, the power controller 270 generates a voltage control signal VC, and the first power generator 240 generates the first power voltage ELVDD1 of the first voltage level or the second voltage level based on the voltage control signal VC. For example, the power controller 270 generates the voltage control signal VC including a plurality of pulses. The first power generator 240 generates the first power voltage ELVDD1 of the first voltage level based on the voltage control signal VC in the first display mode. The first power generator 240 generates the first power voltage ELVDD1 of the second voltage level based on the voltage control signal VC in the transition period.

In one example embodiment, the power controller 270 generates a selection control signal SC, and the power selector 260 selects the driving power based on the selection control signal SC. For example, the power selector 260 may select the first power voltage ELVDD1 as the driving power based on the selection control signal SC to provide the first power voltage ELVDD1 to the power supply line in the first display mode. The power selector 260 may select the first power voltage ELVDD1 and the second power voltage ELVDD2 as the driving power based on the selection control signal SC to provide the first power voltage ELVDD1 and the second power voltage ELVDD2 to the power supply line in the transition period. The power selector 260 selects the second power voltage ELVDD2 as the driving power based on the selection control signal SC to provide the second power voltage ELVDD2 to the power supply line in the second display mode.

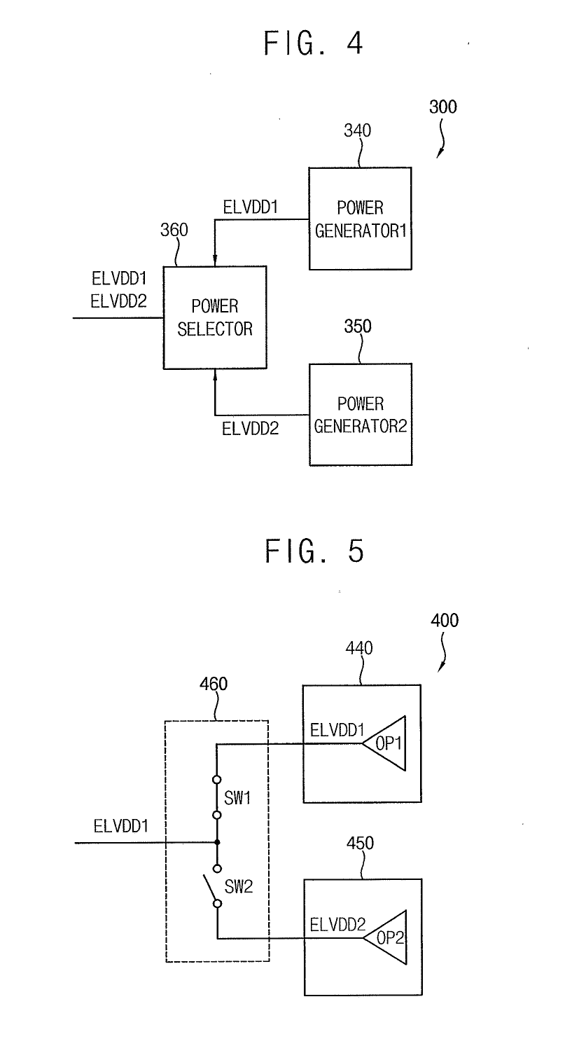

FIG. 4 illustrates an embodiment of a power supply device 300 which includes a first power generator 240, a second power generator 350, and a power selector 360. The first power generator 340 generates a first power voltage ELVDD1 having a first voltage level in a first display mode and having a second voltage level in a transition period between the first display mode and a second display mode. The first display mode may be a normal display mode and the second display mode may be a power saving display mode, e.g., a reduced power mode. The voltage level for the first display mode may different from a voltage level for the second display mode. In another embodiment, the first and second display modes may be different reduced power modes.

In one example embodiment, the second power consumption of the pixel in the second display mode may be lower than a first power consumption of the pixel in the first display mode. The display device 300 may be included in or coupled to a portable device. The portable device may include, for example, a battery having a limited battery capacity. To promote efficient use of the battery, the portable device may reduce power consumption in different situations. The display device 300 may change a display mode in these different situations to reduce power consumption.

For example, power consumption of the display device 300 may be reduced by selecting the second display mode. In one example embodiment, the first time length of one frame in the first display mode may be different from the second time length of one period in the second display mode. For example, the first time length may be shorter than the second time length. The second power consumption in the second display mode may be reduced by setting the second time length longer than the first time length.

In one embodiment, the second voltage level may be in a voltage resistant range which the second power generator 350 may tolerate. The voltage resistant range includes, for example, the voltage level of the second power voltage ELVDD2.

The second power generator 350 generates the second power voltage ELVDD2. The second power consumption of the pixel in the second display mode may be lower than the first power consumption of the pixel in the first display mode. Therefore, the output voltage of the second power generator 350 may be lower than the output voltage of the first power generator 340.

The power selector 360 may select driving power to provide the first power voltage ELVDD1 to the power supply line in the first display mode, to provide the second power voltage ELVDD2 to the power supply line in the second display mode, and to provide the first power voltage ELVDD1 and the second power voltage ELVDD2 to the power supply line in the transition period. The power supply line may receive the first power voltage ELVDD1 and the second power voltage ELVDD2 at the same time. Thus, although the output terminal of the first power generator 340 is electrically connected to the output terminal of the second power generator 350, the first power generator 340 and/or the second power generator 350 may be not damaged because the first power voltage ELVDD1 has the second voltage level in the transition period.

In one example embodiment, the power selector 360 selects the driving power by controlling a first output impedance of the first power generator 340 and a second output impedance of the second power generator 350. The output terminal of the first power generator 340 and the output terminal of the second power generator 350 are connected to the power supply line. The power selector 360 increases the first output impedance of the first power generator 340 (e.g., to a Hi-Z state) to effectively disconnect the output terminal of the first power generator 340 from the power supply line. The power selector 360 increases the second output impedance of the second power generator 350 (e.g., to a Hi-Z state) to effectively disconnect the output terminal of the second power generator 350 from the power supply line.

Further, the power selector 360 decreases the first output impedance of the first power generator 340 and the second output impedance of the second power generator 350 to respectively connect the output terminal of the first power generator 340 to the power supply line and the output terminal of the second power generator 350 to the power supply line. The power selector 360 therefore selects the driving power in this manner.

In one example embodiment, the transition period includes a first period and a second period. The first power voltage ELVDD1 of the second voltage level may be applied to the power supply line in the first period. The second power voltage ELVDD2 and the first power voltage ELVDD1 of the second voltage level may be applied to the power supply line in the second period. For example, after the first power voltage ELVDD1 is changed to the second voltage level in the first period, the power selector 360 provides the second power voltage ELVDD2 and the first power voltage ELVDD1 of the second voltage level to the power supply line in the second period. In one example embodiment, the time length of the first period may be substantially the same as the time length of one frame.

In one example embodiment, the power selector 360 includes a first switch and a second switch. The first switch is between the first power generator 340 and the power supply line. The second switch is between the second power generator 350 and the power supply line. The first switch is turned on in the first display mode and the transition period and is turned off in the second display mode. The second switch is turned off the first display mode and the first period and is turned on in the second display mode and the second period. The power selector 360 selects the driving power by controlling the first and second switches.

Because the first power generator 340 generates the first power voltage ELVDD1 of the second voltage level in transition period, the first power generator 340 and the second power generator 350 may be not damaged when the display modes are changed.

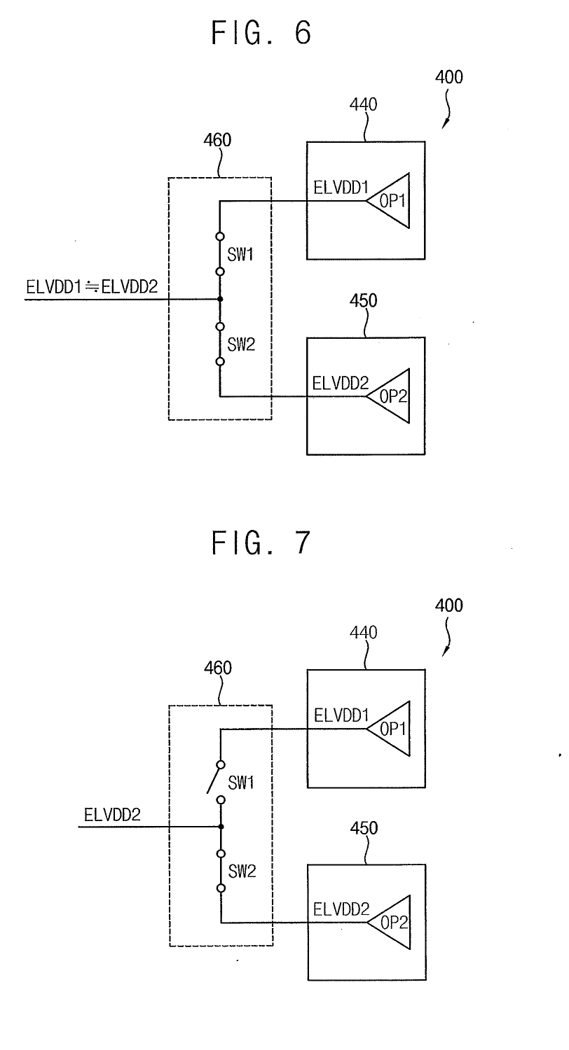

FIG. 5 illustrating an embodiment of the power supply generator 400 in FIG. 4. The power supply generator 400 provides the first power voltage to a power supply line in a first display mode. FIG. 6 is a circuit diagram illustrating that the power supply generator 400 of FIG. 4 provides the first power voltage and a second power voltage to a power supply line in a transition period. FIG. 7 is a circuit diagram illustrating that a power supply generator 400 of FIG. 4 provides the second power voltage to a power supply line in a second display mode.

Referring to FIGS. 5 to 7, the power supply generator 400 includes a first power generator 440, a second power generator 450, and a power selector 460. The first power generator 440 includes a first op-amp OP1 and the second power generator 450 includes a second op-amp OP2. The power selector 460 includes a first switch SW1 and a second switch SW2. The first switch SW1 is between the first power generator 440 and the power supply line. The second switch SW2 is between the second power generator 450 and a power supply line.

Referring to FIG. 5, the first switch SW1 is turned on in the first display mode and the second switch SW2 is turned off the first display mode. The first power generator 440 generates the first power voltage ELVDD1 of a first voltage level. Therefore, the power supply device 400 provides the first power voltage ELVDD1 of the first voltage level to the power supply line.

Referring to FIG. 6, the first switch SW1 is turned on in the transition period and the second switch SW2 is turned on the transition period. The first power generator 440 generates the first power voltage ELVDD1 of a second voltage level. Therefore, the power supply device 400 provides the first power voltage ELVDD1 of the second voltage level and/or the second power voltage ELVDD2 to the power supply line.

Referring to FIG. 7, the first switch SW1 is turned off in the second display mode and the second switch SW2 is turned on the second display mode. Therefore, the power supply device 400 may provide the second power voltage ELVDD2 to the power supply line. As previously indicated, the first and second power voltage levels may be different from 9V and 6V, respectively, other embodiments.

In accordance with another embodiment, a power controller includes an interface and a selector to output signals through the interface, the signals to select driving power for a display, the selector to select a first power voltage for output to a power supply line in a first display mode, a second power voltage for output to the power supply line in the second display mode, and the first and second power voltages for output to the power supply line in the transition period between the first mode and the second mode.

The first power voltage is output from a first generator and the second power voltage is output from a second generator. The second voltage level is in a tolerance range of the second power generator. The selector generates one or more first signals to control output impedance of the first and second generators in the first display mode, generate one or more second signals to control output impedance of the first and second generators in the second display mode, and generate one or more third signals to control output impedance of the first and second generators in the transition period. The control signals may be any of the signals in the aforementioned embodiments for controlling output impedance of the power generators.

The interface may take various forms. For example, when the power controller is embodied in an integrated circuit chip, the interface may be one or more output terminals, leads, wires, ports, signal lines, or other type of interface without or coupled to the power controller. The controller may correspond to one or more of the selector, control, and/or switching circuits in the aforementioned embodiments. In this case, the selector may, for example, correspond to any of the power selectors in the aforementioned embodiments.

The controllers, drivers, selectors, generators, and other processing features of the embodiments disclosed herein may be implemented in logic which, for example, may include hardware, software, or both. When implemented at least partially in hardware, the controllers, drivers, selectors, generators, and other processing features may be, for example, any one of a variety of integrated circuits including but not limited to an application-specific integrated circuit, a field-programmable gate array, a combination of logic gates, a system-on-chip, a microprocessor, or another processing or control circuit.

When implemented in at least partially in software, the controllers, drivers, selectors, generators, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods herein.

By way of summation and review, each pixel in one type of display is supplied with power voltages generated by different power generators based on display modes. When the display mode is changed, the power voltage generated by one power generator may be applied as an external impulse voltage through an output terminal of another power generator. When the external impulse voltage exceeds a predetermined range, the power generator receiving the external impulse voltage may be damaged.

In accordance with one or more of the aforementioned embodiments, a display device includes a display panel, a panel driver, a timing controller, a first generator, a second generator, and a power selector. The power selector selects driving power to provide a first power voltage to a power supply line in a first display mode, to provide a second power voltage to the power supply line in a second display mode, and to provide the first power voltage and the second power voltage to the power supply line in a transition period. The first and second power voltages may be simultaneously applied to the power supply line in the transition period. Therefore, the output terminal of a first power generator may be electrically connected to the output terminal of a second power generator. Because the first power voltage has a second voltage level in the transition period, the first power generator and/or the second power generator may be not damaged.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A display device, comprising:
a display panel including a pixel connected to a power supply line;
a panel driver to drive the display panel;
a timing controller to control the panel driver;
a first power generator to generate a first power voltage of a first voltage level in a first display mode and a second voltage level in a transition period between the first display mode and a second display mode;
a second power generator to generate a second power voltage; and
a power selector to select a driving power to provide the first power voltage to the power supply line in the first display mode, the second power voltage to the power supply line in the second display mode, and the first power voltage and the second power voltage to the power supply line in the transition period.

2. The display device as claimed in claim 1, wherein the second voltage level is in a voltage resistant range which the second power generator tolerates.

3. The display device as claimed in claim 2, wherein the voltage resistant range includes a voltage level of the second power voltage.

4. The display device as claimed in claim 1, wherein the second power generator is in the panel driver.

5. The display device as claimed in claim 1, wherein the power selector is to select the driving power by controlling a first output impedance of the first power generator and a second output impedance of the second power generator.

6. The display device as claimed in claim 1, wherein:
the transition period includes a first period and a second period,
the first power voltage of the second voltage level is to be applied to the power supply line in the first period, and
the second power voltage and the first power voltage of the second voltage level are to be applied to the power supply line in the second period.

7. The display device as claimed in claim 6, wherein a time length of the first period is substantially equal to a time length of one frame.

8. The display device as claimed in claim 6, wherein the power selector includes:
a first switch between the first power generator and the power supply line; and
a second switch between the second power generator and the power supply line.

9. The display device as claimed in claim 8, wherein:
the first switch is to be turned on in the first display mode and the transition period and is to be turned off in the second display mode, and
the second switch is to be turned off the first display mode and the first period and is to be turned on in the second display mode and the second period.

10. The display device as claimed in claim 1, further comprising:
a power controller to control the first power generator.

11. The display device as claimed in claim 10, wherein:
the power controller is to generate a voltage control signal, and
the first power generator is to generate the first power voltage of the first voltage level or the second voltage level based on the voltage control signal.

12. The display device as claimed in claim 11, wherein:
the power controller is to generate a selection control signal, and
the power selector is to select the driving power based on the selection control signal.

13. The display device as claimed in claim 1, wherein a first time length of one frame in the first display mode is different from a second time length of one period in the second display mode.

14. The display device as claimed in claim 13, wherein the first time length is shorter than the second time length.

15. The display device as claimed in claim 1, wherein less power is consumed in the second display mode than in the first display mode.

16. A power supply device, comprising:
a first power generator to generate a first power voltage of a first voltage level in a first display mode and a second voltage level in a transition period between the first display mode and a second display mode;
a second power generator to generate a second voltage; and
a power selector to select a driving power to provide the first power voltage to a power supply line in the first display mode, the second power voltage to the power supply line in the second display mode, and the first power voltage and the second power voltage to the power supply line in the transition period.

17. The power supply device as claimed in claim 16, wherein:
the transition period includes a first period and a second period, and
the first power voltage of the second voltage level is applied to the power supply line in the first period, and the second power voltage and the first power voltage of the second voltage level are applied to the power supply line in the second period.

18. A controller, comprising:
an interface; and
a selector to output signals through the interface, the signals to select a first power voltage for output to a power supply line in a first display mode, a second power voltage for output to the power supply line in the second display mode, and the first and second power voltages for output to the power supply line in a transition period between the first mode and the second mode, wherein at least one of the first and second power voltages has a different level in the transition mode than in the first and second display modes and wherein the level of the first power voltage is in a predetermined tolerance range of a power generator in the transition period.

19. The controller as claimed in claim 18, wherein:
the first power voltage is output from a first generator,
the second power voltage is output from a second generator.

20. The controller as claimed in claim 19, wherein the selector is to:
generate one or more first signals to control output impedance of the first and second generators in the first display mode,
generate one or more second signals to control output impedance of the first and second generators in the second display mode, and
generate one or more third signals to control output impedance of the first and second generators in the transition period.
